(19) United States
(12) Patent Application Publication
(10) Pub. No.: US 2016/0261132 A1
(43) Pub. Date: Sep. 8, 2016

(54) HYBRID POWER DELIVERY SYSTEM FOR AN ELECTRONIC DEVICE

(71) Applicant: INTEL CORPORATION, Santa Clara, CA (US)

(72) Inventor: Alexander B. UAN-ZO-LI, Hillsboro, OR (US)

(21) Appl. No.: 15/035,026

(22) PCT Filed: Dec. 27, 2013
(86) PCT No.: PCT/US13/78127

§ 371 Date: May 6, 2016

(51) Int. Cl. H02J 7/00

(52) U.S. Cl. CPC H02J 7/0068; H02J 7/0052; H02J 7/007; H02J 2007/0001; H02J 2007/0059

(57) ABSTRACT

An electronic device may include circuitry to determine a type of an AC/DC adapter coupled to the input port, and to change a power flow based on the determined type of the AC/DC adapter.

### BACKGROUND

1. Field

Embodiments may relate to a power delivery system for an electronic device.

2. Background

Electronic devices, such as mobile platforms, may continue to decrease in size. A large component of the mobile platform may be a power delivery system that may include a core voltage regulator (VR) and a charger. A user may desire that adapters for the electronic devices may become smaller and more portable over time. For example, it may be desirable to decrease sizes of the VRs and the adapter, without negatively affecting performance. Additionally, an electronic device may be powered from non-traditional power supplies (i.e., wireless charging, universal serial bus (USB) power delivery (PD)), which may have lower or much lower output power than other adapters.

### BRIEF DESCRIPTION OF THE DRAWINGS

Arrangements and embodiments may be described in detail with reference to the following drawings in which like reference numerals refer to like elements and wherein:

FIG. 1 is a diagram of an electronic device according to an example arrangement;

FIG. 2 is a diagram of a power delivery system according to an example arrangement;

FIG. 3 is a diagram of a power delivery system according to an example arrangement; and

FIG. 4 is a diagram of a power delivery system according to an example embodiment.

### DETAILED DESCRIPTION

In the following detailed description, like numerals and characters may be used to designate identical, corresponding and/or similar components in differing figure drawings. Further, in the detailed description to follow, example sizes/models/values/ranges may be given although arrangements and embodiments may not be limited to the same. Where specific details are set forth in order to describe example embodiments, it should be apparent to one skilled in the art that embodiments may be practiced without these specific details.

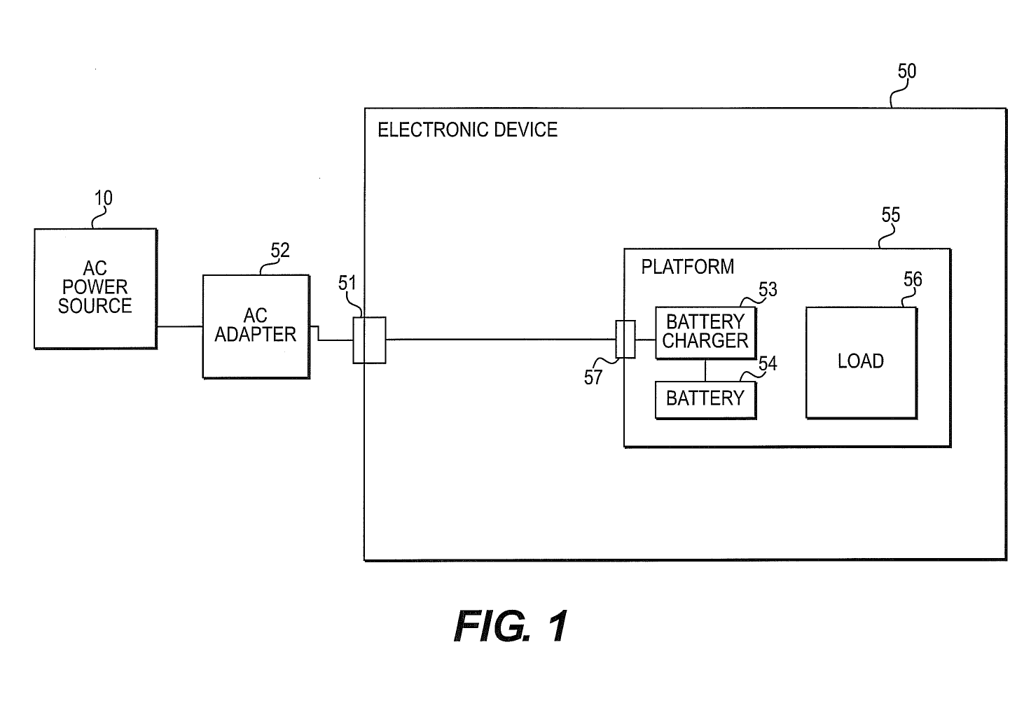

FIG. 1 is a diagram of an electronic device to be powered by an AC adapter according to an example arrangement. Other arrangements and configurations may also be provided.

More specifically, FIG. 1 shows an electronic device 50 directly coupled to an alternating current (AC) power source 10. The AC power source 10 may provide AC power to an AC adapter 52, which may provide direct current (DC) for the electronic device 50. The AC adapter 52 may also be called an AC/DC adapter. The received power may be used to power components of the electronic device 50. The received power may also be stored in a battery provided in a battery port of the electronic device 50. The AC adapter 52 (and/or the AC/DC adapter) may be external to the electronic device.

The electronic device 50 may be a mobile terminal, a mobile device, a mobile computing platform, a laptop computer, a tablet, an ultra-mobile personal computer, a mobile Internet device, a smartphone, a personal digital assistant, a television (TV) set, a monitor and/or etc. Other electronic devices may also be used.

The electronic device 50 may include an input port 51 (to couple to the AC adapter 52), and a platform 55 that includes an input port 57, a battery charger 53, a battery port to receive a battery 54 (or other charge storage device) and a load 56. The platform 55 may be a mobile platform, for example.

The load 56 may be any device or component on the electronic device 50 (or coupled to the electronic device 50) that operates based on a received voltage. For example, the load 56 may be a display device, a memory, a processor, a controller, an input/output device, etc.

FIG. 1 shows the AC adapter 52 being external (and separate) to the electronic device 50.

The AC power source 10 may provide an AC voltage (or AC power) to the input port 51, which in turn provides the AC voltage to the AC adapter 52. The AC adapter 52 may convert the received AC voltage to a DC voltage. The AC adapter 52 may also be considered an AC/DC adapter or an AC/DC converter.

If the AC adapter 52 is external to the electronic device 50, then the AC adapter 52 may receive an AC voltage from the AC power source 10 and provide a DC voltage to the input port 57 (and to the battery charger 53 or directly to the battery 54). For ease of description, the following description may relate to the AC adapter being external to the electronic device 50.

The DC voltage may be provided from the input port 57 to the battery charger 53 (or charger). The battery charger 53 may provide the DC voltage to the battery 54 (provided at the battery port). The DC voltage may also, or alternatively, be provided to the load 56 (directly or indirectly via the battery charger 53) so as to operate the electronic device 50. For example, the DC voltage may be used to power a display device (or other component) on the electronic device 50. A voltage regulator may also be provided on the platform 55 of the electronic device 50 to stabilize the voltage prior to being provided to a load. The battery 54 may be connected directly to the AC adapter 52 output in one implementation.

The AC adapter 52 may be designed to receive AC power from the AC power source 10 (i.e., an AC outlet) at a specific frequency (such as a low frequency of 50 Hertz (Hz)) and to have a voltage that may vary (such as from 90 Vrms to 265 Vrms) based on a country where the AC adapter 52 is used, for example.

It may be desirable for a power delivery system to accommodate adapters with a wide range of maximum output powers, while minimizing system size and maximizing system performance. In at least one arrangement, a hybrid power boost (HPB) system may be used as the power delivery system. In at least one embodiment, a Narrow VDC (NVDC) system may be used as power delivery system.

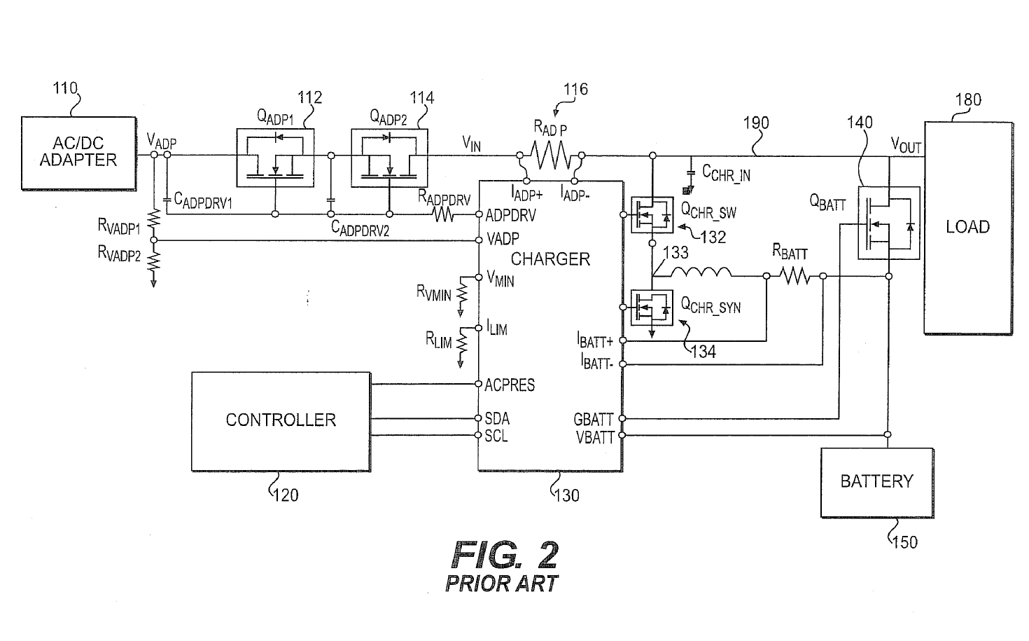

FIG. 2 is a diagram of a power delivery system according to an example arrangement. Other arrangements and configurations may also be provided.

FIG. 2 shows a power delivery system using a Hybrid Power Boost (HPB) system (or technique). More specifically, FIG. 2 shows an AC/DC adapter 110, a controller 120, a charger 130 (or charger controller), a battery 150 (such as in a battery port) and a load 180. The components of the power delivery system shown in FIG. 2 may be provided within the electronic device.

In the FIG. 2 arrangement, the charger is considered to be in parallel to the load 180 (or the system). During operation, the AC/DC adapter may provide power to the load 180, and may provide power to the battery (i.e., charging the battery) independently.

In at least one embodiment, the AC/DC adapter 110 may be external to the electronic device. In at least one embodiment, the AC/DC adapter may be internal to the electronic device.

The VDC may vary between a lowest battery voltage and a highest adapter voltage.

The power delivery system may include a first pass switch 112 and a second pass switch 114 connected in series with the AC/DC adapter 110. The first pass switch 112 and/or the second pass switch 114 may each be a separate field effect transistor (FET).

A sense resistor 116 may be provided in series with the first and second pass switches 112, 114. The sense resistor 116 may be used to conduct the current from the input voltage V_{IN} to the output voltage V_{OUT} along a voltage rail 190. The output voltage V_{OUT} may be provided along the voltage rail 190 to the load 180.

The charger 130 may be connected to both ends of the sense resistor 116. The charger 130 may sense the current (i.e., the adapter current) based on signals received at inputs I_{ADP+} and I_{ADP-} of the charger 130.

A battery switch 140 (QBATT) may be provided between the voltage rail 190 and the battery 150. The battery switch 140 may provide power from the battery 150 to the load 180. The battery switch 140 may be turned ON when the AC/DC adapter 110 is disconnected. The battery 150 may then provide power to the load 180.

The power delivery system may also include a first charger switch 132 and a second charger switch 134. The first charger switch 132 and the second charger switch 134 may each be a field effect transistor (FET). The first charger switch 132 may be coupled between the voltage rail 190 and a node 133. The second charger switch 134 may be coupled between the node 133 and ground. The first and second charger switches 132, 134 may be independently controlled by the charger 130. As one example, the first and second charger switches 132, 134 may be controlled to operate as a boost converter for providing power to the load 180. For example, the first and second charger switches 132, 134 may operate as a boost converter such that the battery 150 may supplement the AC/DC adapter 110 in providing power to the load 180.

As one example of the FIG. 2 arrangement using HPB, when the AC/DC adapter 110 is physically connected to components of the power delivery system, the first and second pass switches 112, 114 (Q_{ADP}1 and Q_{ADP2}) may be turned ON by the charger 130 (ADPDRV output), and the battery switch 140 (Qbatt) may be turned OFF by the charger 130 (G_{BATT} output). The charger 130 may control the first and second charger switches 132, 134 (Q_{CHR}_{_}_{SW} and Q_{CHR}_{_}_{SYN}) to switch in order to charge the battery 150. The first and second charger switches 132, 134 may operate as a buck converter by the charger 130 (or charger controller), and be used to charge the battery 150.

The charger 130 may monitor the current (i.e., the adapter output current) through the sense resistor 116 (R_{ADP}). When the charger 130 determines that the current exceeds a prescribed limit, then the charger 130 may control the first and second charger switches 132, 134 to operate as a boost converter, and the battery 150 may supplement the AC/DC adapter 110 by providing power to the load 180.

The power delivery system of the FIG. 2 arrangement may operate to provide voltage from both the AC/DC adapter 110 and the battery 150 when the current is determined to exceed a prescribed limit.

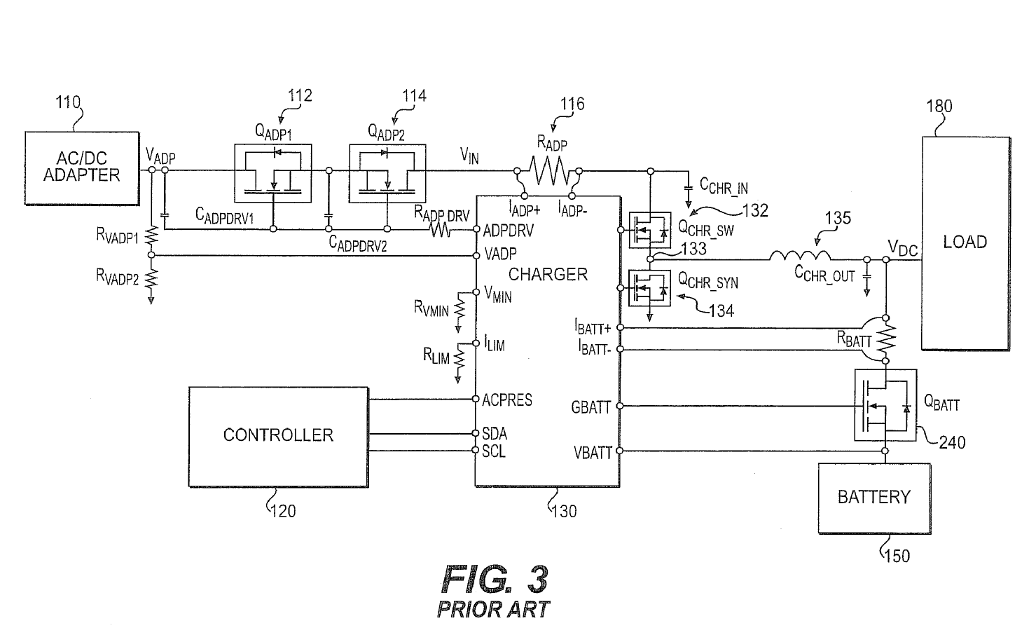

FIG. 3 is a diagram of a power delivery system according to an example arrangement. Other arrangements and configurations may also be provided.

FIG. 3 shows a power delivery system using a Narrow VDC (NVDC) system. The NVDC system may utilize a power-path selection architecture. The NVDC system may include a battery charger and power-path selection switches. The NVDC system may operate such that when an AC/DC adapter is physically connected and is on, then the AC/DC adapter is connected to a VDC node via the charger 130 and its power switches 132, 134 and inductor 135. When the AC/DC adapter is no longer connected, then the battery may connect to the VDC node through a battery switch and provide power to the load (such as via a DC/DC converter).

More specifically, FIG. 3 shows the AC/DC adapter 110, the controller 120, the charger 130, the battery 150 (or battery port) and the load 180. The components of the power delivery system shown in FIG. 3 may be provided within the electronic device.

In the FIG. 3 arrangement, the charger is considered in series with the load 180 (or the system). If the AC/DC adapter is not connected to the power delivery system, then the power may be provided from the battery.

The power delivery system may include the first pass switch 112 and the second pass switch 114 connected in series with the AC/DC adapter 110. The sense resistor 116 may be provided in series with the first and second pass switches 112, 114. The sense resistor 116 may receive an input voltage Vin.

The charger 130 (or charger controller) may be connected to both ends of the sense resistor 116. The charger 130 (or charger controller) may sense the current (i.e., the adapter current) based on signals received at inputs I_{ADP+} and I_{ADP-} to the charger 130. A battery switch 240 (Q_{BATT}) may be provided between a battery resistor R_{BATT} and the battery 150 to provide power to the battery 150. An output signal of the charger 130 (G_{BATT} output) may control the state of the battery switch 240. The battery switch 240 may be turned ON when the AC/DC adapter is disconnected. The battery 150 may then provide power to the load 180.

The power delivery system may also include the first and second charger switches 132, 134 provided in series. The first charger switch 132 may be coupled between a voltage rail and the node 133. The second charger switch 134 may be coupled between the node 133 and ground. The first and second charger switches 132, 134 may be independently controlled by the charger 130. The first and second charger switches 132, 134 may be controlled for providing power to the load 180 via an inductor 135 and a voltage rail (shown as V_{DC}).

As one example of the FIG. 3 arrangement using a NVDC system, when the AC/DC adapter 110 is physically connected to the power delivery system, the first and second pass switches 112, 114 (Q_{ADP}1 and Q_{ADP2}) may be turned ON by the charger 130 (ADPDRV output), and the charger 130 may provide all the power to the load 180, including charging the battery 150. The charger 130 (or charger controller) may control the first and second charger switches 132, 134 to convert the power of the AC/DC adapter 110 to a voltage level of the battery 150, which is always connected to the load 180. The power coming from the adapter 110 and converted to the battery voltage by the charger circuit may be used to charge the battery 150 and support the power demand of the load 180 (or system). If the load 180 (or system) power demand exceeds the power capabilities of the adapter 110, then the battery 150 may automatically supplement the adapter 110.

In at least one arrangement, an electronic device may feature a thermal design power (TDP) of approximately 30 W, while a Turbo level may be 45 W, for example. In order to minimize a system size, a maximum power of the charger may be limited to only approximately 12 W, which may allow the first and second charger switches to be integrated in the charger controller.

However, a user may desire to have two different choices for the AC/DC adapter, namely a larger unit (such as a 45 W unit) that allows the system operation and battery charging, and a smaller unit (such as a 12 W unit) that may be good for travel and over-night charging.

Power delivery with a HPB system may fully use the larger adapter (such as the 45 W adapter), but may not support a smaller adapter (such as the 12 W adapter), because the charger may not supplement the adapter with 33 W for a long enough time duration. As a result, turbo levels may be limited for the system with the power delivery when a small adapter is used.

On the other side, the NVDC system may not see much improvement when a larger adapter (45 W) is connected to the power delivery system. However, the system may be discharging the battery even when using a large adapter. When a smaller adapter (12 W) is used, the system may fully utilize the small adapter without any issues.

Embodiments may provide a power delivery system to take advantages of both a HPB power delivery systems (FIG. 2) and a narrow VDC (NVDC) power delivery systems (FIG. 3). The power delivery system of FIG. 2 may be used when the power delivery system operates from a large AC/DC adapter, whereas the NVDC power delivery system of FIG. 3 may be used for the power system when the power delivery system operates from a small AC/DC adapter. Embodiments may allow flexible use of adapters (both small and large) without limitations on system performance, and a small charger. A user may be able to use smaller systems and choose between using a travel adapter or a larger adapter.

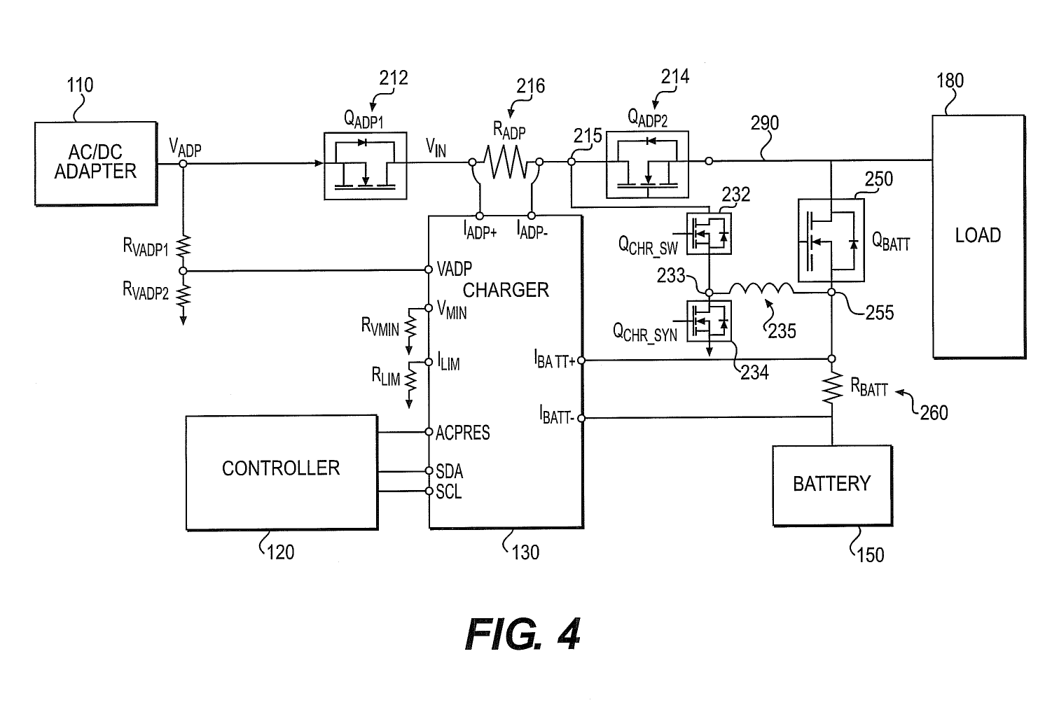

FIG. 4 is a diagram of a power delivery system according to an example embodiment. Other embodiments and configurations may also be provided.

FIG. 4 shows the AC/DC adapter 110 (at an input port), the controller 120, the charger 130, the battery 150 (or battery port) and the load 180. The components of the power delivery system shown in FIG. 4 may be provided within the electronic device, such as the electronic device 50 shown in FIG. 1.

In the FIG. 4 embodiment, the power delivery system may operate in a first mode (such as the HPB system) when a larger adapter is connected, and the power delivery system may operate in a second mode (such as NVDC system) when a smaller adapter is connected. Circuitry may determine a type of AC/DC adapter to couple to an input port and the circuitry may control (or change) a power flow based on the determined type of the AC/DC adapter. As one example, a larger adapter may be considered a first type of adapter having a first power level, and a second adapter may be considered a second type of an adapter having a second power level.

In at least one embodiment, the AC/DC adapter 110 may be considered as a part of the electronic device.

The power delivery system may include a first pass switch 212, a sense resistor 216 and a second pass switch 214 connected in series between the AC/DC adapter 110 and a voltage rail 290. The first pass switch 212 and/or the second pass switch 214 may each be a separate field effect transistor (FET). The voltage rail 290 may be coupled to the load 180. The first pass switch 212 and the second pass switch 214 may be separately and independently controlled by the charger 130.

The sense resistor 216 may also be provided between the first pass switch 212 and the second pass switch 214. The charger 130 may individually control the switches (or switch devices) based on the determined power level of the AC/DC adapter.

The charger 130 may be connected to both ends of the current resistor 216. The charger 130 may sense the current (i.e., the adapter current) based on signals received at inputs I_{ADP+} and I_{ADP-} of the charger 130.

A battery switch 250 (Q_{BATT}) may be provided between the voltage rail 290 and node 255. The battery switch may be a field effect transistor.

A battery resistor 260 (R_{BATT}) may be provided between the node 255 and the battery 150. The charger 130 may be connected to both ends of the battery resistor 260 (R_{BATT}). Accordingly, the battery switch 250, the battery resistor 260 and the battery 150 may be coupled in series. The charger 130 may sense the current based on signals received at inputs I_{BATT+} and I_{BATT-} of the charger 130 and use it to control the battery charge/discharge current.

The power delivery system may also include a first charger switch 232 and a second charger switch 234. The first charger switch 232 and the second charger switch 234 may be field effect transistors. The first charger switch 232 may be coupled between a node 215 and a node 233. The second charger switch 234 may be coupled between the node 233 and ground. The first charger switch 232 and the second charger switch 234 may be controlled by the charger 130.

Additionally, an inductor 235 may be provided between the node 233 and the node 255.

FIG. 4 shows that the first pass switch 212 and the second pass switch 214 are split apart from each other by the sense resistor 216 being provided between the first pass switch 212 and the second pass switch 214. FIG. 4 also shows that the first and second charger switches 232, 234 are connected to the node 215 between the sense resistor 216 and the second pass switch 214. This may allow current from the AC/DC adapter 110 to flow through the first pass switch 212, the sense resistor 215, the first charger switch 232 and the inductor 235 to reach the node 255 and charge the battery 150.

The operation of the circuit as a function of the size of the input AC/DC adapter 110 may be described below.

The charger 130 (or circuitry) may determine a power capability of the AC/DC adapter 110 connected to an input node. Based on the determined power (or power level of the AC/DC adapter), the power delivery system may operate in a first mode by providing a first power flow, or may operate in a second mode by providing a second power flow. The circuitry may provide a first power flow based on a first power level of the AC/DC adapter, and the circuitry may provide a second power level based on a second power level of the AC/DC adapter.

In the first mode (such as the HPB system), the first and second pass switches 212, 214 may be ON and the battery switch 250 may be OFF. The first power flow may then be from the AC/DC adapter to the load 180 along the voltage rail, and the battery 150 may be charged by operation of the first and second charger switches 232, 234 and inductor 235. As one example, the charger switches 232, 234 may be switching in a complementary mode and form a buck converter with the inductor 235.

In the second mode (such as the NVDC system), the first pass switch 212 may be ON, the second pass switch 214 may be OFF, and the battery switch 250 may be ON. The second power flow may then be from the AC/DC adapter 110, through the first charger switch 232 through the inductor 235 and to the load 180, including charging the battery 150. The charger switches 232, 234 may be switching in a complimentary mode and may form a buck converter with the inductor 235.

When a large AC/DC adapter 110 is connected to the power delivery system (e.g. with larger output power capability than the charger), the first and second pass switches 212, 214 may be turned ON, and the battery switch 250 may be turned OFF. The power delivery system may operate in a same manner as the FIG. 2 arrangement, with the charger 130 being in parallel to the load 180.

In an example of a 45 W adapter (i.e., a large adapter) being connected to the power delivery system, the charger 130 (e.g. designed to deliver 12 W) may continuously at the same time use 12 W from the AC/DC adapter 110 to charge the battery 150, and may use up to 33 W from the AC/DC adapter 110 for the load 180. The total power consumed continuously from the adapter may be 45 W, for example. If the load power consumption exceeds the power capability of the adapter, the charger may operate switches 232 and 234, and the inductor 235 as a boost converter to supplement the adapter 110 output power with the battery 150 output power.

In an example of a small AC/DC adapter 110 (e.g. a 15 W adapter) being connected to the power delivery system, the first pass switch 212 may be ON, and the second pass switch 214 may be OFF. The battery switch 250 may be turned on, and the battery 150 may be connected to the load 180 via the battery switch 250. In this example, the charger 130 may operate as in a same manner as the FIG. 3 arrangement with the charger 130 being in series with the load 180 (or the system). The charger 130 may operate as the NVDC system. That is, the power delivered to the load 180 from the adapter 110 may not exceed design power of the charger 130. If the load power consumption exceeds the power capability of the adapter, the charger may operate in a current-limiting mode, and the battery 150 may supplement the charger output power.

The following examples pertain to further embodiments.

Example 1 is an electronic device comprising: a load, an input port to receive an alternate current/direct current (AC/DC) adapter, a battery port to receive a battery, and circuitry to determine a type of the AC/DC adapter when coupled to the input port, and to control a power flow to the load, to the battery, or to both the load and the battery based on the determined type of the AC/DC adapter.

In Example 2, the subject matter of Example 1 can optionally include that the circuitry to control the power flow by controlling at least one switch device.

In Example 3, the subject matter of Example 1 can optionally include that the circuitry to provide a first power flow based on a first power level of the AC/DC adapter, and the circuitry to provide a second power flow based on a second power level of the AC/DC adapter.

In Example 4, the subject matter of Example 1 and Example 3 can optionally include that the circuitry includes a charger to determine the power level of the AC/DC adapter.

In Example 5, the subject matter of Example 1 and Example 4 can optionally include that the circuitry includes a plurality of switch devices, and the charger to individually control the plurality of switch devices based on the determined power level of the AC/DC adapter.

In Example 6, the subject matter of Example 1 and Example 4 can optionally include that the charger to be in series with the load when the power flow is to be the first power flow.

In Example 7, the subject matter of Example 1 and Example 6 can optionally include that the first power flow to be from the input port to the load.

In Example 8, the subject matter of Example 1 and Example 4 can optionally include that the charger to be in parallel with the load when the power flow is to be the second power flow.

In Example 9, the subject matter of Example 1 can optionally include that the circuitry includes a sense resistor.

In Example 10, the subject matter of Example 1 and Example 9 can optionally include that the power flow is to be to the battery when current across the sense resistor exceeds a prescribed value.

In Example 11, the subject matter of Example 1 and Example 10 can optionally include that the circuitry includes a boost converter to be used when the power flow is to the battery.

In Example 12, the subject matter of Example 1 and Example 9 can optionally include that the power flow is to be to the load when the current across the sense resistor is less than a prescribed value.

In Example 13, the subject matter of Example 1 and Example 9 can optionally include that the circuitry includes a buck converter.

Example 14 is an apparatus comprising: circuitry to determine a type of alternate current/direct current (AC/DC), and circuitry to control power flow based on the determined type of the AC/DC adapter.

In Example 15, the subject matter of Example 14 can optionally include that the circuitry to control the power flow by controlling at least one switch device.

In Example 16, the subject matter of Example 14 can optionally include that the circuitry to provide a first power flow based on a first power level of the AC/DC adapter, and the circuitry to provide a second power flow based on a second power level of the AC/DC adapter.

In Example 17, the subject matter of Example 14 and Example 16 can optionally include that the circuitry includes a charger to determine the power level of the AC/DC adapter.

In Example 18, the subject matter of Example 14 and Example 17 can optionally include that the circuitry includes a plurality of switch devices, and the charger to individually control the plurality of switch devices based on the determined power level of the AC/DC adapter.

In Example 19, the subject matter of Example 14 can optionally include that the circuitry includes a sense resistor.

In Example 20, the subject matter of Example 14 can optionally include that the circuitry includes a boost converter.

In Example 21, the subject matter of Example 14 can optionally include that the circuitry includes a buck converter.

Example 22 is an apparatus comprising: means for determining a type of an alternate current/direct current (AC/DC) adapter, and means for controlling a power flow based on the determined type of the AC/DC adapter.

In Example 23, the subject matter of Example 22 can optionally include that the means for controlling to change the power flow by controlling at least one switch device.

In Example 24, the subject matter of Example 22 can optionally include that the means for controlling to provide a first power flow based on a first power level of the AC/DC adapter, and the means for controlling to provide a second power flow based on a second power level of the AC/DC adapter.

In Example 25, the subject matter of Example 22 and Example 24 can optionally include that the means for determining includes a charger to determine the power level of the AC/DC adapter.

In Example 26, the subject matter of Example 22 and Example 25 can optionally include that the means for controlling includes a plurality of switch devices, and the means for controlling to individually control the plurality of switch devices based on the determined power level of the AC/DC adapter.

In Example 27, the subject matter of Example 22 can optionally include that the means for controlling includes a sense resistor.

In Example 28, the subject matter of Example 22 can optionally include that the means for controlling includes a boost converter.

Example 29 is a method comprising: determining a type of alternate current/direct current (AC/DC), and controlling power flow based on the determined type of AC/DC adapter.

In Example 30, the subject matter of Example 29 can optionally include that controlling the power flow includes controlling the power flow by controlling at least one switch device.

In Example 31, the subject matter of Example 29 can optionally include that controlling the power flow includes providing a first power flow based on a first power level of the AC/DC adapter, and providing a second power flow based on a second power level of the AC/DC adapter.

In Example 32, the subject matter of Example 29 and Example 31 can optionally include that a charger determines the power level of the AC/DC adapter.

In Example 33, the subject matter of Example 29 and Example 32 can optionally include individually controlling a plurality of switch devices based on the determined power level of the AC/DC adapter.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device comprising:
a load;
an input port to receive an alternate current/direct current (AC/DC) adapter;
a battery port to receive a battery; and
circuitry to determine a type of the AC/DC adapter when coupled to the input port, and to control a power flow to the load, to the battery, or to both the load and the battery based on the determined type of the AC/DC adapter.

2. The electronic device of claim 1, wherein the circuitry to control the power flow by controlling at least one switch device.

3. The electronic device of claim 1, wherein the circuitry to provide a first power flow based on a first power level of the AC/DC adapter, and the circuitry to provide a second power flow based on a second power level of the AC/DC adapter.

4. The electronic device of claim 3, wherein the circuitry includes a charger to determine the power level of the AC/DC adapter.

5. The electronic device of claim 4, wherein the circuitry includes a plurality of switch devices, and the charger to individually control the plurality of switch devices based on the determined power level of the AC/DC adapter.

6. The electronic device of claim 4, wherein the charger to be in series with the load when the power flow is to be the first power flow.

7. The electronic device of claim 6, wherein the first power flow to be from the input port to the load.

8. The electronic device of claim 4, wherein the charger to be in parallel with the load when the power flow is to be the second power flow.

9. The electronic device of claim 1, wherein the circuitry includes a sense resistor.

10. The electronic device of claim 9, wherein the power flow is to be to the battery when current across the sense resistor exceeds a prescribed value.

11. The electronic device of claim 10, wherein the circuitry includes a boost converter to be used when the power flow is to the battery.

12. The electronic device of claim 9, wherein the power flow is to be to the load when the current across the sense resistor is less than a prescribed value.

13. The electronic device of claim 9, wherein the circuitry includes a buck converter.

14. An apparatus comprising:
circuitry to determine a type of alternate current/direct current (AC/DC); and
circuitry to control power flow based on the determined type of the AC/DC adapter.

15. The apparatus of claim 14, wherein the circuitry to control the power flow by controlling at least one switch device.

16. The apparatus of claim 14, wherein the circuitry to provide a first power flow based on a first power level of the AC/DC adapter, and the circuitry to provide a second power flow based on a second power level of the AC/DC adapter.

17. The apparatus of claim 16, wherein the circuitry includes a charger to determine the power level of the AC/DC adapter.

18. The apparatus of claim 14, wherein the circuitry includes a boost converter.

19. The apparatus of claim 14, wherein the circuitry includes a buck converter.

20. An apparatus comprising:
means for determining a type of an alternate current/direct current (AC/DC) adapter; and
means for controlling a power flow based on the determined type of the AC/DC adapter.

21. The apparatus of claim 20, wherein the means for controlling to change the power flow by controlling at least one switch device.

22. The apparatus of claim 20, wherein the means for controlling to provide a first power flow based on a first power level of the AC/DC adapter, and the means for controlling to provide a second power flow based on a second power level of the AC/DC adapter.

23. A method comprising:
determining a type of alternate current/direct current (AC/DC); and
controlling power flow based on the determined type of AC/DC adapter.

24. The method of claim 23, wherein controlling the power flow includes controlling the power flow by controlling at least one switch device.

25. The method of claim 23, wherein controlling the power flow includes providing a first power flow based on a first power level of the AC/DC adapter, and providing a second power flow based on a second power level of the AC/DC adapter.
